(19) United States
(12) Patent Application Publication
(10) Pub. No.: US 2007/0255878 A1
(43) Pub. Date: Nov. 1, 2007

(54) Motherboard assembly

(75) Inventor: Ying-Chih Shen, Taichung Hsien (TW)

Correspondence Address: OSTROLENK FABER GERB & SOFFEN, 1180 AVENUE OF THE AMERICAS, NEW YORK, NY, 100368403, US

(73) Assignee: Universal Scientific Industrial Co., Ltd.

(21) Appl. No.: 11/411,503

(22) Filed: Apr. 26, 2006

(51) Int. Cl. G06F 13/00

(52) U.S. Cl. 710/300

(57) ABSTRACT

A computer motherboard includes an expansion slot that complies with a Peripheral Component Interconnect Express (PCIEx1 and PCIEx4) specification and an Advance Digital Display 2 lane-reversed (ADD2-R) specification, and that includes a set of conductive pins complying with the Peripheral Component Interconnects (PCI) specification. A riser card may be inserted removably into the expansion slot, and includes a first slot that complies with the PCIEx1 specification, and a second slot that complies with the PCI specification.

### BACKGROUND OF THE INVENTION

1. Field of the Invention

The invention relates to a motherboard assembly, more particularly to a motherboard assembly with an expansion slot that complies with two different specifications.

2. Description of the Related Art

A conventional computer motherboard includes a pair of expansion slots, each of which complies with a respective one of the Peripheral Component Interconnect Express (PCIE) specification and the Advance Digital Display 2 (ADDR-2) specification.

The aforementioned conventional computer motherboard is disadvantageous in that it includes the two separate expansion slots, thereby resulting in a larger size for the computer motherboard and in higher manufacturing costs.

### SUMMARY OF THE INVENTION

Therefore, the object of the present invention is to provide a computer motherboard that is capable of overcoming the aforesaid drawbacks associated with the prior art.

According to the present invention, a computer motherboard comprises an expansion slot that complies with a Peripheral Component Interconnect Express x1 (PCIEx1) specification and an Advance Digital Display 2 lane-reversed (ADD2-R) specification, and that includes a set of conductive pins complying with the Peripheral Component Interconnects (PCI) specification.

### BRIEF DESCRIPTION OF THE DRAWINGS

Other features and advantages of the present invention will become apparent in the following detailed description of the preferred embodiment with reference to the accompanying drawings, of which:

FIG 1 is a schematic block diagram of the preferred embodiment of a motherboard assembly according to the present invention;

FIG. 2 is a schematic view to illustrate two riser cards that are used in conjunction with an expansion slot of the preferred embodiment; and

FIG. 3 is a schematic view to illustrate two interface cards that are used in conjunction with an expansion slot of the preferred embodiment.

### DETAILED DESCRIPTION OF THE PREFERRED EMBODIMENT

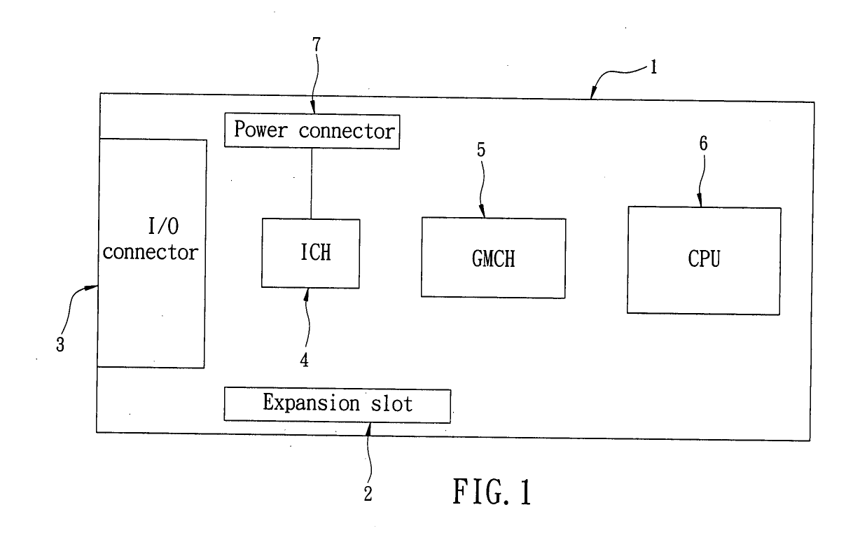

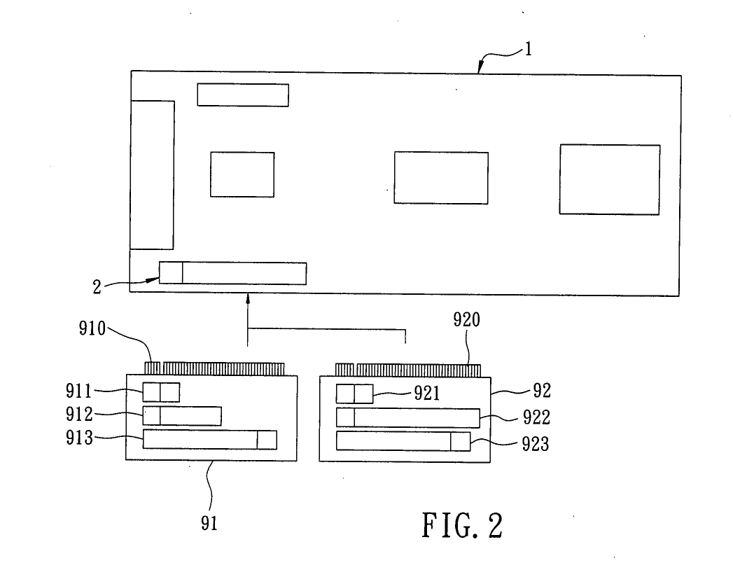

Referring to FIGS. 1 and 2, the preferred embodiment of a motherboard assembly according to this invention is shown to include a computer motherboard 1, and first and second riser cards 91, 92.

The computer motherboard 1 includes an expansion slot 2, an I/O connector 3, an I/O controller hub (ICH) 4, a graphic memory controller hub (GMCH) 5, a central processing unit (CPU) 6, and a power connector 7.

Since the feature of the present invention does not reside in particular configurations of the I/O connector 3, the ICH 4, the GMCH 5, the CPU 6, and the power connector 7, which are conventional in construction, a detailed description of the same is omitted herein for the sake of brevity.

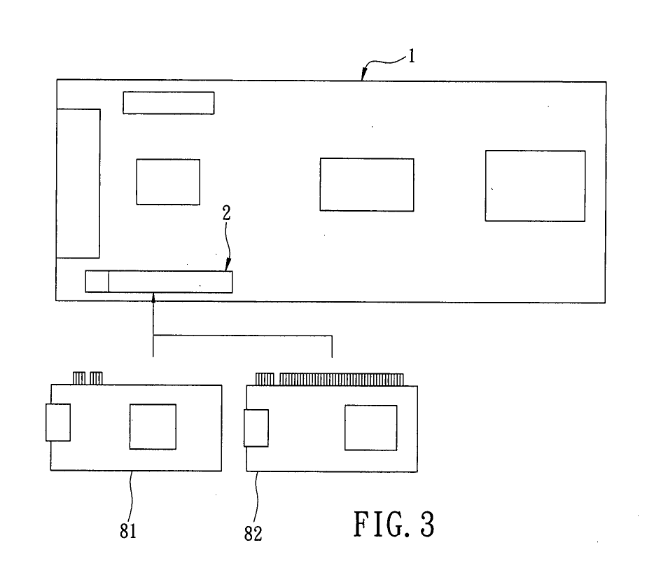

In this embodiment, the expansion slot 2 of the computer motherboard 1 complies with the Peripheral Component Interconnect Express x1 (PCIEx1) specification and the Advance Digital Display 2 lane-reversed (ADD2-R) specification, and includes a set of conductive pins that complies with the Peripheral Component Interconnects (PCI) specification. Accordingly, the expansion slot 2 of the computer motherboard 1 is capable of supporting a PCIEx1 compliant interface card 81 (see FIG. 3) and an ADD2-R compliant interface card 82 (see FIG. 3).

It is noted that the expansion slot 2 of the computer motherboard 1 has 164 conductive pins, each of which is defined as illustrated in Table 1 below.

TABLE 1

| Pin | Definition | Specification | Pin | Definition | Specification |
|---|---|---|---|---|---|
| A1 | RSNT1* | PCIEx1 | B1 | 12 V | PCIEx1 and ADD2-R |
| A2 | 12 V | PCIEx1 and ADD2-R | B2 | 12 V | PCIEx1 and ADD2-R |
| A3 | 12 V | PCIEx1 and ADD2-R | B3 | 12 V | PCIEx1 and ADD2-R |
| A4 | GND | PCIEx1 and ADD2-R | B4 | GND | PCIEx1 and ADD2-R |
| A5 | JTAG2 | PCIEx1 | B5 | SMCLK | PCIEx1 |
| A6 | JTAG3 | PCIEx1 | B6 | SMDAT | PCIEx1 |
| A7 | JTAG4 | PCIEx1 | B7 | GND | PCIEx1 and ADD2-R |
| A8 | JTAG5 | PCIEx1 | B8 | VCC3 | PCIEx1 and ADD2-R |
| A9 | VCC3 | PCIEx1 and ADD2-R | B9 | JTAG1 | PCIEx1 |
| A10 | VCC3 | PCIEx1 and ADD2-R | B10 | 3.3VAUX | PCIEx1 and ADD2-R |
| A11 | PWRGD | PCIEx1 and ADD2-R | B11 | WAKE# | PCIEx1 |
| A12 | GND | PCIEx1 and ADD2-R | B12 | RISER_DETECT | None |
| A13 | REFCLK+ | PCIEx1 | B13 | GND | PCIEx1 and ADD2-R |
| A14 | REFCLK− | PCIEx1 | B14 | HSOP0 | PCIEx1 |
| A15 | GND | PCIEx1 and ADD2-R | B15 | HSON0 | PCIEx1 |
| A16 | HSIP0 | PCIEx1 | B16 | GND | PCIEx1 and ADD2-R |
| A17 | HSIN0 | PCIEx1 | B17 | SDVO_CTRL_CLK | ADD2-R |
| A18 | GND | PCIEx1 and ADD2-R | B18 | GND | PCIEx1 and ADD2-R |
| A19 | VCC5 | PCI | B19 | −12 V | PCI |
| A20 | PCI_INTE− | PCI | B20 | VCC5 | PCI |
| A21 | PCI_INTG− | PCI | B21 | VCC5 | PCI |
| A22 | VCC5 | PCI | B22 | PCI_INTF− | PCI |
| A23 | VCC5 | PCI | B23 | PCI_INTH− | PCI |
| A24 | PCIRST− | PCI | B24 | GND | PCI |
| A25 | VCC5 | PCI | B25 | PCI_CLK_2 | PCI |
| A26 | PCI_GNT1− | PCI | B26 | GND | PCI |
| A27 | GND | PCI | B27 | PCI_CLK_1 | PCI |
| A28 | PCI_PME− | PCI | B28 | PCI_REQ1− | PCI |
| A29 | AD30 | PCI | B29 | GND | PCI |
| A30 | VCC3 | PCI | B30 | AD31 | PCI |
| A31 | GND | PCI | B31 | SDVO_CTRL_DATA | ADD2-R |
| A32 | AD28 | PCI | B32 | GND | PCI |
| A33 | AD26 | PCI | B33 | AD29 | PCI |
| A34 | AD24 | PCI | B34 | GND | PCI |
| A35 | GND | PCI | B35 | AD27 | PCI |
| A36 | AD22 | PCI | B36 | AD25 | PCI |
| A37 | AD20 | PCI | B37 | VCC3 | PCI |
| A38 | GND | PCI | B38 | C_BE− (3) | PCI |
| A39 | AD18 | PCI | B39 | AD23 | PCI |
| A40 | AD16 | PCI | B40 | GND | PCI |
| A41 | VCC3 | PCI | B41 | AD21 | PCI |
| A42 | PCI_FRAME− | PCI | B42 | AD19 | PCI |
| A43 | GND | PCI | B43 | VCC3 | PCI |
| A44 | PCI_TRDY− | PCI | B44 | AD17 | PCI |
| A45 | GND | PCI | B45 | C_BE− (2) | PCI |
| A46 | PCI_STOP− | PCI | B46 | PCI_IRDY− | PCI |
| A47 | VCC3 | PCI | B47 | GND | PCI |
| A48 | GND | PCI | B48 | EXP_EN | PCI |
| A49 | PCI_PAR | PCI | B49 | GND | PCI |
| A50 | AD15 | PCI | B50 | VCC3 | PCI |
| A51 | VCC3 | PCI | B51 | PCI_DEVSEL− | PCI |
| A52 | AD13 | PCI | B52 | GND | PCI |
| A53 | AD11 | PCI | B53 | PCI_LOCK− | PCI |
| A54 | GND | PCI | B54 | PCI_PERR− | PCI |
| A55 | AD9 | PCI | B55 | VCC3 | PCI |
| A56 | C_BE− (0) | PCI | B56 | PCI_SERR− | PCI |
| A57 | VCC3 | PCI | B57 | C_BE− (1) | PCI |
| A58 | AD6 | PCI | B58 | VCC3 | PCI |
| A59 | AD4 | PCI | B59 | AD14 | PCI |
| A60 | GND | PCI | B60 | AD12 | PCI |
| A61 | AD2 | PCI | B61 | AD10 | PCI |
| A62 | AD1 | PCI | B62 | AD8 | PCI |
| A63 | ADO | PCI | B63 | AD7 | PCI |
| A64 | PCI_REQ2− | PCI | B64 | GND | PCIEx4 and ADD2-R |
| A65 | PCI_GNT2− | PCI | B65 | GND | PCIEx4 and ADD2-R |
| A66 | GND | PCI and ADD2-R | B66 | EXP_TXP_12 | PCIEx4 and ADD2-R |
| | | | | SDVO_CLK_P | |
| A67 | GND | PCIEx4 and ADD2-R | B67 | EXP_TXN_12 | PCIEx4 and ADD2-R |
| | | | | SDVO_CLK_N | |
| A68 | EXP_RXP_12 | PCIEx4 | B68 | GND | PCIEx4 and ADD2-R |
| A69 | EXP_RXN_12 | PCIEx4 | B69 | GND | PCIEx4 and ADD2-R |
| A70 | GND | PCIEx4 and ADD2-R | B70 | EXP_TXP_13 | PCIEx4 and ADD2-R |
| | | | | SDVO_BLUE_P | |
| A71 | GND | PCIEx4 and ADD2-R | B71 | EXP_TXN_13 | PCIEx4 and ADD2-R |
| | | | | SDVO_BLUE_N | PCIEx4 and ADD2-R |
| A72 | EXP_RXP_13 | PCIEx4 and ADD2-R | B72 | GND | PCIEx4 and ADD2-R |
| | SDVO_STALL_P | | | | |
| A73 | EXP_RXN_13 | PCIEx4 and ADD2-R | B73 | GND | PCIEx4 and ADD2-R |
| | SDVO_STALL_N | | | | |
| A74 | GND | PCIEx4 and ADD2-R | B74 | EXP_TXP_14 | PCIEx4 and ADD2-R |
| | | | | SDVO_GREEN_P | |
| A75 | GND | PCIEx4 and ADD2-R | B75 | EXP_TXN_15 | PCIEx4 and ADD2-R |
| | | | | SDVO_GREEN_N | |
| A76 | EXP_RXP_14 | PCIEx4 and ADD2-R | B76 | GND | PCIEx4 and ADD2-R |
| | SDVO_INT_P | | | | |
| A77 | EXP_RXN_14 | PCIEx4 and ADD2-R | B77 | GND | PCIEx4 and ADD2-R |
| | SDVO_INT_N | | | | |
| A78 | GND | PCIEx4 and ADD2-R | B78 | EXP_TXP_15 | PCIEx4 and ADD2-R |
| | | | | SDVO_RED_P | |
| A79 | GND | PCIEx4 and ADD2-R | B79 | EXP_TXN_15 | PCIEx4 and ADD2-R |
| | | | | SDVO_RED_N | |
| A80 | EXP_RXP_15 | PCIEx4 and ADD2-R | B80 | GND | PCIEx4 and ADD2-R |
| A81 | EXP_RXN_15 | PCIEx4 and ADD2-R | B81 | AD5 | PCI |
| A82 | GND | PCIEx4 and ADD2-R | B82 | AD3 | PCI |

The first riser card 91 includes conductive pins 910 and first, second and third slots 911, 912, 913. Each of the conductive pins 910 of the first riser card 91 establishes an electrical contact with a respective one of the conductive pins of the expansion slot 2 of the computer motherboard 1 when the first riser card 91 is inserted into the expansion slot 2. In this embodiment, the first slot 911 of the first riser card 91 complies with the PCIEx1 specification. The second slot 912 of the first riser card 91 complies with the PCI specification. The third slot 913 of the first riser card complies with the ADD2-R specification. Accordingly, with the use of the first riser card 91, the expansion slot 2 of the computer motherboard 1 is capable of supporting the PCIEx1 compliant interface card 81, the ADD2-R compliant interface card 82, and a PCI compliant interface card (not shown).

In an alternative embodiment, the first slot 911 of the first riser card 91 complies with the PCIEx1 specification. The second slot 912 of the first riser card 91 complies with the PCI specification. The third slot 913 of the first riser card complies with the PCIEx4 and ADD2 non-lane-reversed (ADD2-N) specification.

Similarly, the second riser card 92 includes conductive pins 920 and three slots 921, 922, 923. Each of the conductive pins 920 of the second riser card 92 establishes an electrical contact with a respective one of the conductive pins of the expansion slot 2 of the computer motherboard 1 when the second riser card 92 is inserted into the expansion slot 2. In this embodiment, the first slot 921 of the second riser card 92 complies with the PCIEx1 specification. The second slot 922 of the second riser card 92 complies with the PCI specification. The third slot 923 of the second riser card 92 complies with the ADD2-R specification. Accordingly, with the use of the second riser card 92, the expansion slot 2 of the computer motherboard 1 is capable of supporting the PCIEx1 compliant card 81, the ADD2-R compliant interface card 82, and the PCI compliant interface card.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A computer motherboard, comprising:
an expansion slot complying with the Peripheral Component Interconnect Express x1 (PCIEx1) specification and the Advance Digital Display 2 lane-reversed (ADD2-R) specification, and including a set of conductive pins that complies with the Peripheral Component Interconnect (PCI) specification.

2. A motherboard assembly, comprising:
a computer motherboard;
an expansion slot provided on said computer motherboard, complying with the Peripheral Component Interconnect Express x1 (PCIEx1) specification and the Advance Digital Display 2 lane-reversed (ADD2-R) specification, and including a set of conductive pins that complies with the Peripheral Component Interconnect (PCI) specification; and
a first riser card inserted removably into said expansion slot, and including a first slot that complies with the PCIEx1 specification, and a second slot that complies with the PCI specification.

3. The motherboard assembly as claimed in claim 2, wherein said first riser card further includes a third slot that complies with the ADD2-R specification.

4. The motherboard assembly as claimed in claim 2, wherein said first riser card further includes a third slot that complies with the PCIEx4 specification and the ADD2 non-lane-reversed (ADD2-N) specification.

5. The motherboard assembly as claimed in claim 2, further comprising a second riser card inserted removably into said expansion slot, and including a first slot that complies with the PCIEx1 specification, a second slot that complies with the PCI specification, and a third slot that complies with the ADD2-R specification.
